(19) United States
(12) Patent Application Publication
(10) Pub. No.: US 2008/0172659 A1
(43) Pub. Date: Jul. 17, 2008

(54) HARMONIZING A TEST FILE AND TEST CONFIGURATION IN A REVISION CONTROL SYSTEM

(75) Inventors: Saiyue Yu, Redmond, WA (US); Xun Zhang, Redmond, WA (US)

Correspondence Address: MERCHANT & GOULD (MICROSOFT), P.O. BOX 2903, MINNEAPOLIS, MN, 55402-0903, US

(73) Assignee: MICROSOFT CORPORATION, Redmond, WA (US)

(21) Appl. No.: 11/624,054

(22) Filed: Jan. 17, 2007

(51) Int. Cl. G06F 9/45

(52) U.S. Cl. 717/139

(57) ABSTRACT

A method for harmonizing a test file with a test configuration includes an initial request to commit a test file to a test file repository. The test file is associated with an action comprising creating, deleting, or editing the test file. An associated test configuration is selected and modified according to the action. The test configuration is validated and, if valid, the test file and test configuration is allowed to be committed to a repository.

### BACKGROUND

Software development commonly incorporates automated test systems to perform tests on applications or portions of an application. Test systems allow tests to be performed on components without requiring the entire application to be complete. For example, a test system can impersonate a hardware component so that a user interface can be tested without waiting for the hardware component itself to become available. Test systems also allow for the automation of tests. Automated tests can be developed that test many or even every combination of events, thereby saving human testers the tedium and errors associated with repeatedly entering substantially the same data and/or performing substantially the same actions.

Test developers develop two test components. One test component is the actual test file which contains instructions for the test, the criteria for pass/fail, and the action to take upon a given pass/fail condition. The second component is the test configuration. In a basic testing system a tester may develop a test and install the code to be tested on a target platform (e.g., a personal computer, personal digital assistant, or custom hardware). The target platform is then controlled by the testing system, which may be connected, configured, or executed under the direct control of a human tester. In more sophisticated testing systems, a test may execute with little or no contact by a human test developer, however, certain configurations of the target platform are still required. A test configuration provides an automated test system with the information needed to configure a test platform in order to execute a test. For example, a test configuration may require that a spreadsheet program and plug-in for the spreadsheet program be loaded in order for the test to be performed. Once loaded, the test file may then execute tests on the plug-in developed for the spreadsheet program.

Software development generally comprises adding functionality and fixing bugs within existing software components. Once a developer is satisfied that a particular component is complete, the component may then be committed to a source code repository. This is commonly referred to as “checking-in” the code. The source code repositories often provide versioning for the source code to manage revisions, branches, and roll-backs. Test files go through the same process and generally follow a similar development path as the source code. As an example, a test file contains tests for an application and instructions to mimic the responses of a hardware component not yet available. Once the hardware component becomes available, the test file is modified so that the mimicking portion is removed and tests of the actual hardware component are added. Similarly, the test configuration must evolve with the test file so that required components, such as the hardware component are made available to the component under test.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The above and other problems are solved by embodiments of the present invention, wherein a test configuration is modified in accord with an action associated with a modified test file. In the course of developing a test, an action is performed on a test file. The action includes create, edit, and delete operations. A test engineer requests the changed test file be committed, thereby causing the changes to be preserved in a test file repository and available for execution. Prior to committing the changes, a test configuration is selected and modified according to the action associated with the test file. The selection of the test configuration is based on the test configuration including the test file as a testing resource. Once modified, the test configuration is validated. If the modified test configuration is valid, the modified test file and modified test configurations are allowed to be committed to a repository and becomes available for use by the test systems.

### BRIEF DESCRIPTION OF THE DRAWINGS

FIG. 1 illustrates a flowchart for harmonizing a test file with a test configuration;

FIG. 2 illustrates an interaction diagram for harmonizing a test file and a selected test configuration;

FIG. 3 illustrates a computing system operable to implement embodiments of the disclosure;

FIG. 4 illustrates a sequence diagram for components, such as the client, server, and database illustrated in FIG. 3; and

FIG. 5 illustrates a computing system environment on which embodiments of the disclosure may be implemented.

### DETAILED DESCRIPTION

Example embodiments will now be described more fully hereinafter with reference to the accompanying drawings. These embodiments are provided so that this disclosure will be thorough and complete. Like numbers refer to like elements throughout.

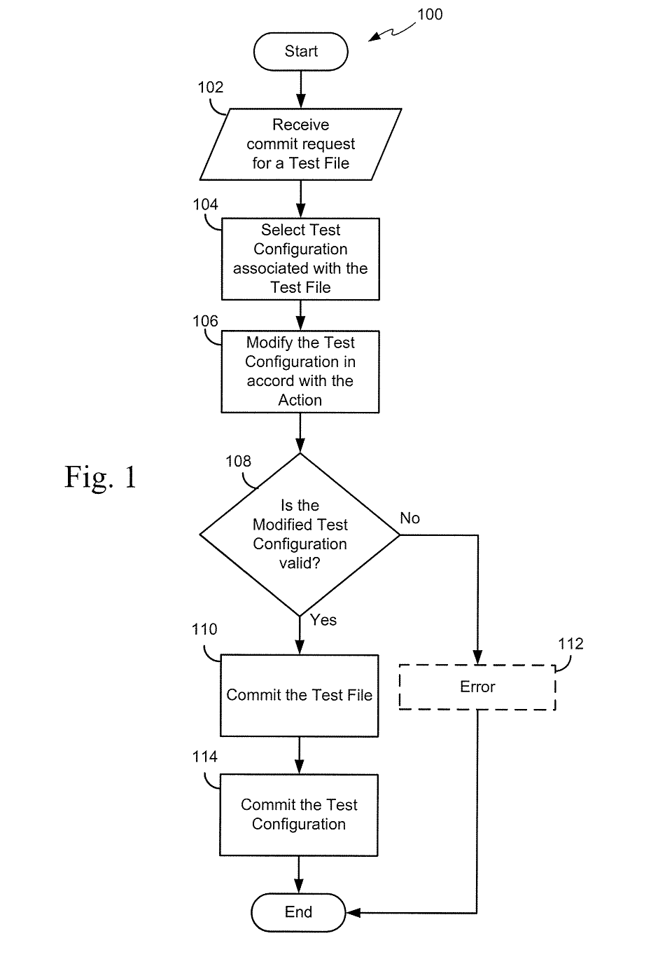

Embodiments of the present invention include modifying a test configuration in accord with an action associated with a modified test file. FIG. 1 illustrates flowchart 100 for harmonizing a test file with a test configuration. Receiving step 102 receives a commit request for a test file. The commit request is associated with a modification operation (herein, “action”) of the test file. The action is one of create, edit, and delete actions. The test file itself contains instructions for execution by a testing system to be performed upon a computing component, such as an application, applet, code segment, hardware, or embedded system. It is understood that the act of committing a test file with a delete action entails signaling the test file repository with the delete action and an identifier of the test file, such as the name of the test file. Providing the test file to be deleted is not required.

The test file and test configuration may be variously embodied. For example, at least one of the test file and test configuration may be a file, as determined by an operating system of a computer executing the steps of flowchart 100. In other embodiments, the test file and/or test configuration is a file portion, database, database portion, object, or other computer-implemented container operable to store data.

The action associated with the test file may be received by various means. In one embodiment, a user interface receives a user's indication of an action. In another embodiment, a user performs operations upon a test file and, based on the operations, the action is determined. More specifically, if a test file is retrieved (checked-out) from the repository and the content of the test file is changed, the determined action is “edit;” while if the request is to commit a test file that has no associated version already in the repository, the determined action is “create;” and if the user deletes the test file, the determined action is “delete.”

Selecting step 104 selects a test configuration associated with the test file. In one embodiment, the test configuration is selected because it includes the test file, or an identifier of the test file, as a test resource. As a result, inquiring into the test configuration's test resources determines whether a particular test file is associated with the test configuration.

Modifying step 106 modifies the test configuration in accord with the action applied to the test file. In one embodiment, the action “creates” the test file, and the test configuration is modified to include the test file as a test resource. Alternatively, a new test configuration is created and associated with the new test file. In a second embodiment, the action “deletes” the test file, and the associated test configuration is either deleted or edited to remove the test file. The determination of whether to remove the test file from the test configuration or to delete the test configuration may be performed in accord with determining whether any additional test files would remain once the test file is deleted from the test configuration. In a third embodiment, the action “edits” the test file, and the associated test configuration is examined to determine if modification is necessary. If the test configuration should remain unchanged, then modifying step 106 has completed. A policy may be implemented to determine if editing the test configuration is required and, if so, the test configuration is modified in step 106 in accord with the policy.

Determination 108 validates the modified test configuration. In one embodiment a policy determines validity of the test configuration. The policy may include a minimum number of test resources, such as at least one operating system and at least one hardware platform, a test execution component. The policy may be determined as a matter of design choice in accord with custom, static, or dynamic rules relevant to the test, platform, or other objective. In another embodiment, the modified test configuration is valid if all test resources required by the test of the test file are included. An index of test and their associated test resources may be implemented in order to determine the required test resources for test in a test file.

Validation fails when the action requires a new test resource, such as when the action is create or edit, and the edit adds a new test requiring a new test resource. With the benefit of an associating resource, such as a linking database or tags within the test file, the test resource to be added is known. The test resource to be added may then be added in modifying step 106. However, the linking database or other resource may not be aware of a secondary test resource required by the first test resource. For example, a test requiring a more advanced operating system causing step 106 to include the advanced operating system as a test resource. However, it may not request advanced hardware required by the advanced operating system. As a result, the modified test configuration may be determined to be invalid by step 108.

If an action causes a test configuration to be modified by step 106 by removing a test resource validation may still fail. Modification step 106 may not initially discover that a removed test resource is still required by remaining tests. For example, removing a test requiring an advanced operating system may fail to select the previous hardware platform. This may result in incomplete test results as the less advanced hardware is now omitted from testing.

If determination 108 confirms the validity of the modified test configuration, step 110 commits the test file to the repository. Commit step 110 authorizes the commitment of the test file to storage. Commit step 110 may be a signal for another process to proceed with the commit operation, removal of a block preventing the commit operation, or performing the commit operation itself. In one embodiment, commit step 110 authorizes the repository to commit the test file to storage by signaling the repository to commit the test file. In another embodiment, commit step 110 authorizes the repository to commit the test file to storage by sending the test file to the repository.

In other embodiments, when determination step 108 determines that the modified test configuration is not valid, the step 110 committing the test file to the repository is blocked and may incorporate error processing step 112. Error processing step 112 may be embodied as a notification to a user of the invalidity of the modified test configuration file. Error processing step 112 may be further embodied as a prompt to a user or computing device to take an action in an attempt to make the test configuration valid. In embodiments in which error processing step 112 may cause an invalid test configuration to become valid, processing may loop back to determination step 108.

When the commit operation is blocked, the test file may be saved as a work-in-progress (as opposed to being committed to the repository where it would become available as a production test file). In another embodiment, processing of the modified test configuration continues until the configuration file is either validated (thereby permitting commitment of the test file to the repository) or discarded.

Upon determination step 108 determining the modified test configuration is valid, test configuration commit step 114 commits the test configuration to storage. Commit step 114 authorizes the commitment of the test configuration to storage. Test configuration commit step 114 may be a signal for another process to proceed with the commit operation, removal of a block preventing the commit operation, or performing the commit operation itself. In one embodiment, test configuration commit step 114 authorizes the repository to commit the test configuration to storage by signaling the repository to commit the test configuration. In another embodiment, test configuration commit step 114 authorizes the repository to commit the test configuration to storage by sending the test configuration to the repository. Commit steps 110 and 114 may be performed in any order, in parallel, or as one operation. In embodiments wherein commit steps 110 and 114 are performed serially, successful completion of the preceding commit step may be a prerequisite to the succeeding commit step.

In another embodiment, a number of test configurations are selected by selecting step 104 and modified by modifying step 106. Step 108 then determines if any of the modified test configurations are valid and, if so, step 110 commits the test file to the repository. Test configuration commit step 114 then commits each modified test configuration. Optionally, step 108 determines if each modified test configuration is valid before commit step 110 is performed. Test configuration commit step 114 then commits valid modified test configurations.

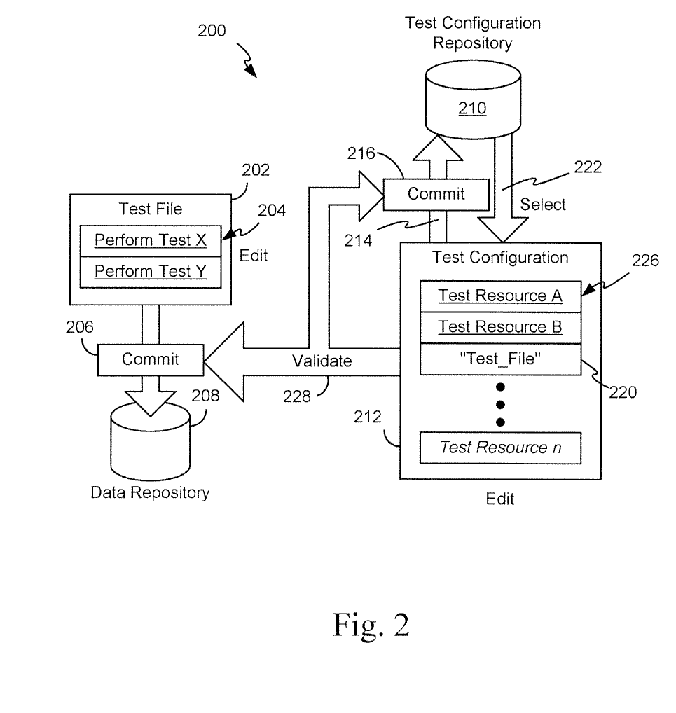

FIG. 2 illustrates interaction diagram 200 for harmonizing test file 202 and selected test configuration 212. In the embodiment illustrated, test file 202 is modified by altering test instructions 204 and, therefore, the action associated with test file 202 is “edit.” Commit process 206 (i.e., the act of committing the modified test file 202 to the repository 208) requires validation signal 228 for authorization to proceed. In another embodiment, test file 202 is first retrieved from the data repository 208 for the application of an edit or delete action.

In order for validation signal 228 to be provided, the associated test configuration 212 is modified and validated. Test configuration repository 210 illustrates a repository for test configuration 212. In another embodiment, test configuration repository 210 and data repository 208 are combined and form portions of one database. A selection process 222 selects test configuration 212 based on the test file identifier 220 indicating test file 202. Selection process 222 may initially select a number of candidate test configurations from test configuration repository 210 and query each candidate to select test configuration 212.

Following the selection process 222, test configuration 212 is modified by altering test resources 226 in accord with the edit action for test file 202. In one embodiment a test instruction (“Perform Test X”) is removed from test file 202. The test instruction required a test resource (“Test Resource A”), which is now unused. As a result, test resources 226 are modified such that the resource associated with the removed test instruction (“Perform Test X”) is removed. In a more specific example, “Test X” tests connectivity to a modem. “Test Resource A” is a modem resource. With the advancement of internal and external networks, such as the Internet, “Test X” (test the modem) is removed and, accordingly, “Resource A” (modem) is removed as a test resource. “Test Y” may then test a network and, therefore, require “Test Resource B” (network interface) be included in test configuration 212.

In embodiments, wherein test file 202 is new and the action is “create,” test file identifier 220 is created. In other embodiments, wherein the test file 202 is deleted and the action is “delete,” test file identifier 220 is deleted from test configuration 212. In an alternate embodiment, such as when the deletion of test file identifier 220 would cause test configuration 212 to be without any test files, test configuration 212 is deleted from test configuration repository 210.

It should be appreciated how to parse a file, such as a test file, and determine the required resources based on entries within a test file. Such entries may utilize another database to look up test resources required for the tests. Test resources may also be listed within the test file itself, such as associated with a tag of an Extensible Markup Language (XML) file or other identifier consistent with other file formats.

Test configuration 212 is validated after modification. If the test configuration 212 is determined to be valid, “validate” signal 228 is sent and authorizes test file 202 to be committed to the repository 208. In another embodiment, upon validation, modified test configuration 212 is also authorized to be committed to test configuration repository 210 and becomes test configuration 212.

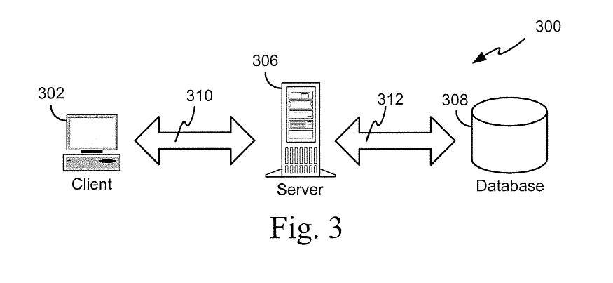

FIG. 3 illustrates computing system 300 operable to implement embodiments of the disclosure. Client 302 and server 306 are communicatively linked via first network portion 310. Server 306 and database 308 are communicatively linked via second network portion 312. In another embodiment, first and second network portions 310, 312 are one network, and client 302, server 306, and database 308 are nodes upon the one network. In another embodiment, and least two of the client 302, the server 306, and the database 308 are executed on the same computing platform. Server 306 is configured to execute processes, such as the test configuration modifying step 106 and/or validation determining step 108.

Database 308 is configured to store data, such as when operating as test file 202 and/or test configuration repository 210. Server 306 is configured to operate repository functionality, such as the configuration file selecting step 104 and/or the test file committing step 110.

In another embodiment, client 302 receives a user's inputs including an explicit or determined action for a test file. In accord with a user action, client 302 selects a test file for modification. Server 306 retrieves the test file from database 308 for presentation by client 302. Client 302 receives the user's inputs and, accordingly, the action associated with the test file. Alternative, client 302 receives a user's input to create a test file. Server 306 then creates a test file for validation and commitment of the new test file to database 308.

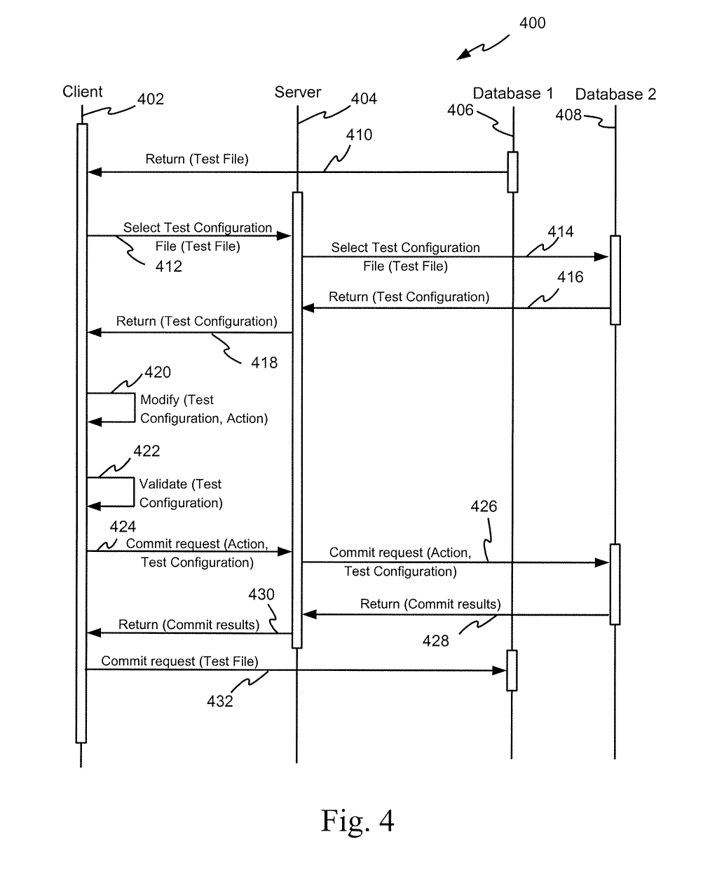

FIG. 4 illustrates an embodiment of sequence diagram 400 for components, such as client 302, server 306, and database 308 illustrated in FIG. 3. Client thread 402 executes on a computing device, such as client 302. Server thread 404 executes on a computing device, such as server 306. Database 1 and database 2, 406 and 408 respectively, are database threads for data repositories and may be embodied in distinct or combined databases, such as database 308. Threads 402, 404, 406, and 408 may each spawn or control a number of machine threads.

In one embodiment, client 402 may have previously retrieved the test file from server 404 and database 1 (406), created the test file, or obtained the test file from another source. In another embodiment, step 410 returns the test file, such as in response to a user's request for the test file or other signal. Step 410 may be the result of an operation from which the action for the test file is determined. For example, step 410 may be performed as a result of a request to edit the test file. Accordingly, the action associated with the test file would be “edit.” When step 410 is performed in response to a delete action, returning the file in step 410 may not be required. Delete actions may result in the test file being returned, such as to allow the user to review the file before the delete operation is committed. When step 410 is performed in response to a create action, step 410 may return an empty file, template file, file identifier to be associated with the new test file, or other indicator. In other embodiments, the action may be received from a user's input or by an analysis of the test file as compared to a previous version of the test file. Step 410 may be omitted, such as when a user creates a test file from scratch or when the user retrieves the test file from another database.

In step 412, client 402 selects from server 404, which in turn performs step 414 to select the test configuration from database 2 (408). Database 2 (408) returns the test configuration to server 404 in step 416, which returns the test configuration to client 402 in step 418.

Step 420 modifies the test configuration in accord with the action. Step 422 validates the modified test configuration. Step 422 may be a parent thread to other processes, a user interface, database, or other component operable to validate or provide data and/or logic in which to validate the modified test configuration.

Step 424 requests the test configuration be committed to database 2 (408), via step 426 whereby server 404 receives the request from client 402 and issues the request to database 2 (408). In one embodiment, the action is included in steps 424 and 426. In embodiments wherein database 2 (408) is operable to determine the action, the action may be omitted from steps 424 and 426. Wherein the action for the test file is “delete,” or otherwise results in the deletion of the test configuration, the test configuration may be an identifier of the test configuration. Steps 428 and 430 notify server 404 and client 402, respectively, of the results of commit step 426. Additional processing may be implemented to attempt to remedy any failure. Upon step 430 returning a success indicator, step 432 is executed to commit the test file to database 1 (406). Step 432 may utilize server 404 to perform commit step 432 on behalf of client 402.

Optionally, step 432 may trigger additional steps (not shown), such as commit result notification to server 404 and/or to client 402. Additional processing may then attempt to remedy any failure to successfully commit the test file. In another embodiment, commit steps 424 and 432 are performed in unison. In still another embodiment, the failure of one commit step 426, 432 results in the other commit step 426 or 432 not being performed. In yet another embodiment, the failure of one commit step 426 or 432 and the success of the other commit step 426 or 432 results in the successful one commit step 426 or 432 being backed out.

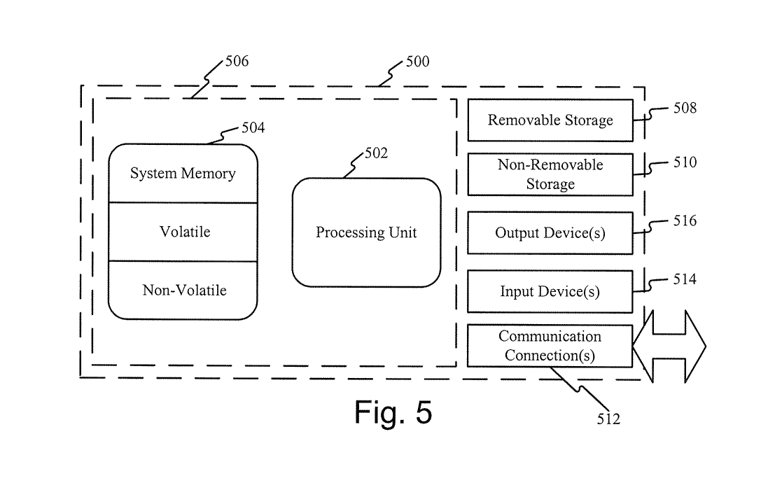

FIG. 5 illustrates one computing environment in which embodiments of the invention may be implemented. The operating environment is only one example of a suitable operating environment and is not intended to suggest any limitation as to the scope of use or functionality of the invention. Other well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

With reference to FIG. 5, an exemplary system for implementing the invention includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.), or some combination of the two. The most basic configuration of the computing device 500 is illustrated in FIG. 5 by dashed line 506. Additionally, device 500 may also have additional features or functionality. For example, device 500 may also include additional storage (removable and/or non-removable) including, but not limited to, magnetic or optical disks or tape. Such additional storage is illustrated in FIG. 5 by removable storage 508 and non-removable storage 510. Computer storage media includes volatile and nonvolatile, removable and non-removable media implemented in any method or technology for storage of information, such as computer readable instructions, data structures, program modules, or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 500. Any such computer storage media may be part of device 500.

Device 500 may also contain communications connection(s) 512 that allow the device to communicate with other devices. Communications connection(s) 512 is an example of communication media. Communication media typically embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media.

Device 500 may also have input device(s) 514 such as keyboard, mouse, pen, voice input device, touch input device, etc. Output device(s) 516 such as a display, speakers, printer, etc. may also be included. The devices 514 may help form the user interface for client 302, discussed above, while processing unit 502 may provide one or more processing threads 402, 404, 406 or 408, discussed above, storage devices 508, 510 may provide storage for database 308, also discussed above, and communications connection(s) 512 may provide first and/or second network portions 310, 312, also discussed above. All these devices are well know in the art and need not be discussed at length here.

Computing device 500 typically includes at least some form of computer readable media. Computer readable media can be any available media that can be accessed by processing unit 502. By way of example, and not limitation, computer readable media may comprise computer storage media and communication media. Combinations of any of the above should also be included within the scope of computer readable media.

The computer device 500 may operate in a networked environment using logical connections to one or more remote computers or storage peripherals (not shown). The remote computer may be a personal computer, a server computer system, a router, a network PC, a peer device, or other common network node, and typically includes many or all of the elements described above relative to the computer device 500. The logical connections between the computer device 500 and the remote computer may include a local area network (LAN) or a wide area network (WAN), but may also include other networks. Such networking environments are commonplace in offices, enterprise-wide computer networks, intranets, and the Internet.

When used in a LAN networking environment, the computer device 500 is connected to the LAN through a network interface or adapter. When used in a WAN networking environment, the computer device 500 typically includes a modem or other means for establishing communications over the WAN, such as the Internet. The modem, which may be internal or external, may be connected to the computer processor 502 via the communication connections 512, or other appropriate mechanism. In a networked environment, program modules or portions thereof may be stored in the remote memory storage device. By way of example, and not limitation, a remote application programs may reside on memory device connected to the remote computer system. It will be appreciated that the network connections explained are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as examples forms of implementing the claims.

What is claimed is:

1. A method for harmonizing a test file with a test configuration, comprising:
receiving a request to commit a test file to a repository;
in response to the request, selecting a test configuration associated with the test file;
modifying the test configuration in accord with an action for the test file; and
authorizing the commitment of the test configuration to the test configuration repository and the test file to the test file repository.

2. The method of claim 1, wherein the step of authorizing occurs upon validating the modified test configuration.

3. The method of claim 1, wherein selecting the test configuration associated with the test file further comprises, comprises selecting the test configuration from a candidate test configuration upon determining the candidate test configuration includes the test file as a test resource.

4. The method of claim 1, further comprising:
identifying a plurality of test configurations for the test file;
modifying the plurality of test configurations in accord with the action for the test file; and
upon determining that the plurality of modified test configurations are valid, committing the test configuration to the test configuration repository and the test file to the test file repository.

5. The method of claim 1, further comprising, retrieving the test file and the action associated with the test file, from the test file repository.

6. The method of claim 1, wherein:
the action for the test file comprises deleting the test file; and
modifying the test configuration comprises disassociating the test file from the test configuration.

7. The method of claim 1, wherein:
the action for the test file comprises deleting the test file; and
modifying the test configuration comprises deleting the test configuration.

8. The method of claim 1, wherein validating the test configuration is successful if all required test resources for the test file are included in the modified test configuration.

9. A computer system, comprising:
a server operable to be logically connected to a client and a repository via a network;
the server being operable to,
receive, from the client, a user's input identifying an action and a test file to be committed to the repository subject to the action;
retrieve a test configuration associated with the test file and return the test configuration to the client;
the client being operable to,
modify the test configuration according to the action for the test file; and
upon validating the modified test configuration, commit the modified test configuration to the repository.

10. The computer system of claim 9, wherein the client is further operable to signal the server to commit the test configuration to the repository on behalf of the client; and
the server is further operable to commit the modified test configuration to the repository.

11. The computer system of claim 9, wherein the client is further operable to, upon validating the modified test configuration, commit the test file to the repository.

12. The computer system of claim 9, wherein the action for the test file comprises deleting the test file, and the server is operable to modify the test configuration by disassociating the test file from the test configuration.

13. The computer system of claim 9, wherein the action for the test file comprises deleting the test file, and the server is operable to modify the test configuration by deleting the test configuration.

14. The computer system of claim 9, wherein the action for the test file comprises editing the test file, and the server is operable to modify the test configuration by authorizing the repository to replace the test configuration stored in the repository with the modified test configuration.

15. The computer system of claim 9, wherein the repository is segmented into a first part, operable as a repository for the test file, and a second part, operable as a repository for the test configuration.

16. A computer-readable medium having computer-executable components comprising:
a server component further comprising, a network interface component operable to receive a test configuration from a repository and operable to receive a test file and an action for the test file;
the server component being operable to,
select a test configuration that references the test file as a test resource;
the client component being operable to,
modify the test configuration in accord with the action for the test file;
validate the modified test configuration, and
upon validating the modified test configuration, signaling the server to commit the modified test configuration to the repository.

17. The computer-readable medium of claim 16, wherein the network interface component is further operable to send the test file to the repository for storage.

18. The computer-readable medium of claim 16, wherein the server component is further operable to select the test configuration from a number of candidate test configurations.

19. The computer-readable medium of claim 16, wherein when the action for the test file is create and the server component is operable to create a new test configuration prior to selecting the test configuration.

20. The computer-readable medium of claim 16, wherein:
the action for the test file is delete and the server component modifies the test configuration by deleting the test configuration; and
upon the server component validating the deletion of the test configuration, authorize committing of a delete operation for the modified test configuration.
